(19) United States
(12) Patent Application Publication
(10) Pub. No.: US 2020/0036665 A1
(43) Pub. Date: Jan. 30, 2020

(54) COGNITIVE ANALYSIS OF SOCIAL MEDIA POSTS BASED ON USER PATTERNS

(71) Applicant: International Business Machines Corporation, Armonk, NY (US)

(72) Inventors: Cesar Augusto Rodriguez Bravo, Alajuela (CR); Edgar A. Zamora Duran, Heredia (CR); Roxana Monge Nunez, Pérez Zeledón (CR)

(21) Appl. No.: 16/044,051

(22) Filed: Jul. 24, 2018

(51) Int. Cl. H04L 12/58; H04L 29/08; G06Q 50/00

(52) U.S. Cl. CPC H04L 51/12; G06Q 50/01; H04L 67/306; H04L 67/22

(57) ABSTRACT

Posts to a social media platform are analyzed to determine if the posts are from the account owner or authorized user. The analysis is carried out based on previously learned patterns identified via the account owner's previous posts and their profile. The learned patterns of the user may be based on topics, sentiment, mood, context, content and other information. The learned patterns of a user are used to identify variation in the user intent relative to the topic of the post. The user profile can be used to determine if the variations are within a threshold range of variations based on user characteristics. Based on the analysis, malicious posts by unauthorized users can be prevented.

### BACKGROUND

The present invention relates to cognitive analysis, and more specifically to cognitive analysis of social media posts based on user patterns.

Social media is widely used around the world. Social media is an electronic communication platform through which users share and create information and ideas, interests and other forms of expression via virtual online communities and networks.

The content of posts made by a user to the social media platform is scrutinized by other users and by potential employers of the user. Therefore, a user has to be careful to ensure that posts to the social media platform are made by only the user. An unauthorized user may gain access to a user's social media platform through an unattended computer, a shared computer or other means. If in fact a post is made by another unauthorized user, a request to the social media organization can be made, but the post may have already been accessed by other users and the reputation associated with the user can already have been damaged.

### SUMMARY

According to one embodiment of the present invention, a method for preventing unwanted or unauthorized actions on a social media platform of a user is disclosed. The method comprising the steps of: a computer receiving a proposed user action for public display on a social media platform associated with a user's account; the computer extracting characteristics of the proposed user action, the characteristics comprising context and content of the proposed user action; the computer comparing the characteristics of the proposed user action to a user baseline associated with the user's account; when the comparison of the characteristics of the proposed user action to the user baseline determines that the characteristics of the proposed user action and the user baseline differ more than a determined threshold, the computer determining user groups associated with the user of the user's account; the computer comparing a baseline of other users in same determined user groups as the user of the user's account to the extracted characteristics of the proposed user action; and when the characteristics of the proposed user action to the baseline of other users in the same determined user groups determines that the characteristics of the proposed user action and the baseline of other users in the same determined user groups differ more than a determined threshold, the computer preventing the action from public display on the social media platform associated with the user's account.

According to another embodiment of the present invention, a computer program product for preventing unwanted or unauthorized actions on a social media platform of a user is disclosed. The computer program product is executed using a computer comprising at least one processor, one or more memories, one or more computer readable storage media, the computer program product comprising a computer readable storage medium having program instructions embodied therewith. The program instructions executable by the computer to perform a method comprising: receiving, by the computer, a proposed user action for public display on a social media platform associated with a user's account; extracting, by the computer, characteristics of the proposed user action, the characteristics comprising context and content of the proposed user action; comparing, by the computer, the characteristics of the proposed user action to a user baseline associated with the user's account; when the comparison of the characteristics of the proposed user action to the user baseline determines that the characteristics of the proposed user action and the user baseline differ more than a determined threshold, determining, by the computer, user groups associated with the user of the user's account; comparing, by the computer, a baseline of other users in same determined user groups as the user of the user's account to the extracted characteristics of the proposed user action; and when the characteristics of the proposed user action to the baseline of other users in the same determined user groups determines that the characteristics of the proposed user action and the baseline of other users in the same determined user groups differ more than a determined threshold, preventing, by the computer, the action from public display on the social media platform associated with the user's account.

A computer system for preventing unwanted or unauthorized actions on a social media platform of a user is disclosed. The computer system comprising a computer comprising at least one processor, one or more memories, one or more computer readable storage media having program instructions executable by the computer to perform the program instructions comprising: receiving, by the computer, a proposed user action for public display on a social media platform associated with a user's account; extracting, by the computer, characteristics of the proposed user action, the characteristics comprising context and content of the proposed user action; comparing, by the computer, the characteristics of the proposed user action to a user baseline associated with the user's account; when the comparison of the characteristics of the proposed user action to the user baseline determines that the characteristics of the proposed user action and the user baseline differ more than a determined threshold, determining, by the computer, user groups associated with the user of the user's account; comparing, by the computer, a baseline of other users in same determined user groups as the user of the user's account to the extracted characteristics of the proposed user action; and when the characteristics of the proposed user action to the baseline of other users in the same determined user groups determines that the characteristics of the proposed user action and the baseline of other users in the same determined user groups differ more than a determined threshold, preventing, by the computer, the action from public display on the social media platform associated with the user's account.

### BRIEF DESCRIPTION OF THE DRAWINGS

FIG. 1 depicts an exemplary diagram of a possible data processing environment in which illustrative embodiments may be implemented.

FIG. 2 illustrates internal and external components of a client computer and a server computer in which illustrative embodiments may be implemented.

FIG. 3 shows a flow diagram of a method of cognitively analyzing social media posts based on user patterns.

### DETAILED DESCRIPTION

In an embodiment of the present invention, posts to a social media platform are analyzed to determine if the posts are from the account owner or authorized user. The analysis is carried out based on previously learned patterns identified via the account owner's previous posts and their profile. The learned patterns of the user may be based on topics, sentiment, mood, context, content and other information. The profile can include, in part, age, culture, gender, education, location and other information associated with the user. The learned patterns of a user are used to identify variation in the user intent relative to the topic of the post. The user profile can be used to determine if the variations are within a threshold range of variations based on user characteristics. Based on the analysis, malicious posts by unauthorized users can be prevented.

In an embodiment of the present invention, it will be recognized that a cognitive social post analysis system can enforce security protocols relative to social networks based on a current user post and determined user baseline based on previously learned patterns associated with the user account and/or their user profile.

Embodiments of the present invention prevent unauthorized actions from taking place relative to a social media account of a user, for example preventing offensive posting, unauthorized posting, friend requests and likes of social media content which are not characteristic or within a threshold of previously learned patterns associated with the user. Embodiments of the present invention preferably prevent unwanted posts by both unauthorized users and authorized users, for example, by preventing an authorized user from posting a gibberish comment to a post or a gibberish post to the social media platform. By using a cognitive social post analysis system to review posts prior to displaying on social media platforms, any posts or actions which are not within a threshold of a user's learned behaviors and account profile are prevented, preventing damage to a user's reputation which could occur via the social media platform.

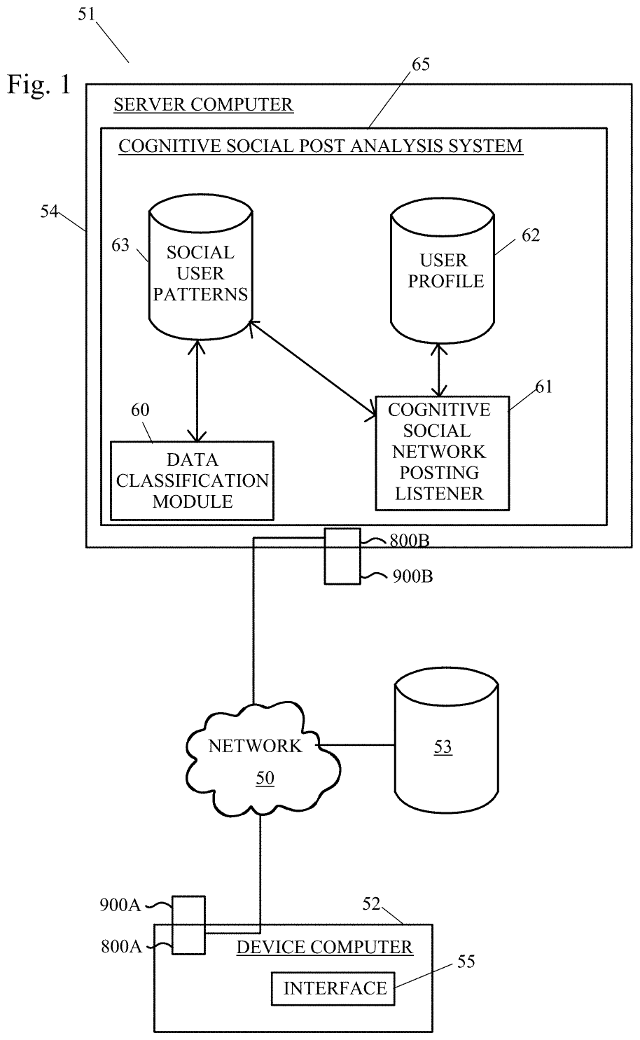

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, a configuration database 53, and a server computer 54 connect to network 50. In other exemplary embodiments, network data processing system 51 may include additional client or device computers, storage devices or repositories, server computers, and other devices not shown. The network 50 preferably includes at least one social network. The at least one social network may be present on a cloud network. The configuration database 53 stores the configuration data for a cognitive social post analysis system 65.

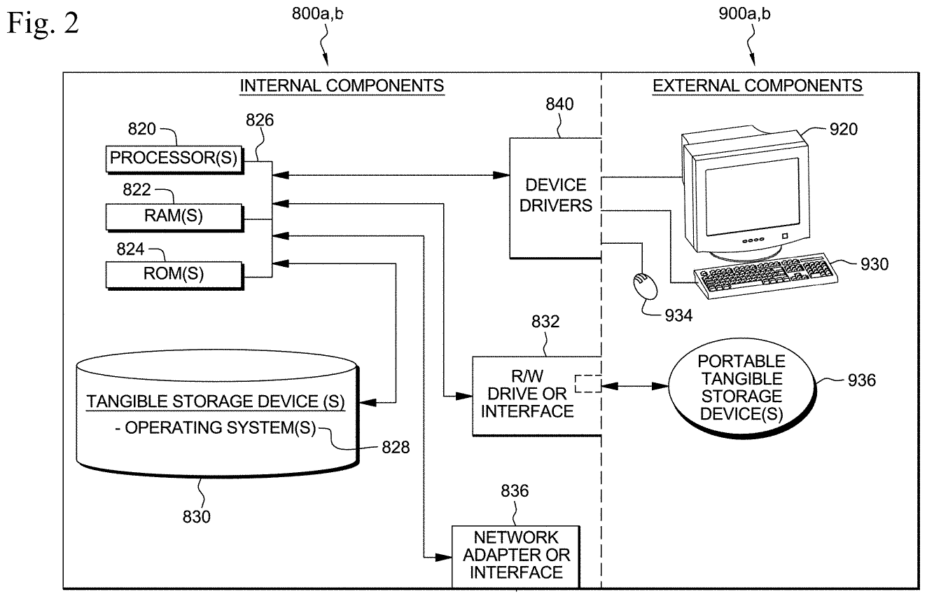

The device computer 52 may contain an interface 55, which may accept commands and data entry from a user. The commands may be regarding a post to a social media platform via a web browser. The interface can be, for example, a command line interface, a graphical user interface (GUI), a natural user interface (NUI) or a touch user interface (TUI). The device computer 52 includes a set of internal components 800a and a set of external components 900a, further illustrated in FIG. 2.

Server computer 54 includes a set of internal components 800b and a set of external components 900b illustrated in FIG. 2. Server computer 54 can compute the information locally or extract the information from other computers on network 50. The server computer 54 can include a cognitive social post analysis system 65. The cognitive social post analysis system 65 can include a data classification module 60, a cognitive social network posting listener 61, a user profile database 62, and social user patterns database 63. The data classification module 60 can be in communication with the social network 50 and the social user patterns database 63. The cognitive social network posting listener 61 can be communication with the social network 50, the user profile database 62, and the social user patterns database 63. Other connections between elements of the cognitive social post analysis system 65 may be present.

The data classification module 60 sorts user actions on social media platforms into actions fields such as: posting, likes, friend request, chats, etc. Under each action field, the action will be categorized into a first category based on the content or context (sports, religious, political, sentimental, professional, etc). Each first category will have subcategories such as: Sports (Soccer, basketball, etc). The data classification module continues with categorization into additional subcategories until no further categorization is relevant.

The social user patterns database 63 stores a user's patterns associated with social media behavior.

The cognitive social network posting listener 61 monitors or “listens” to user's post and actions on social media as they are entered. If a new action is out of the user's patterns, the new action triggers the cognitive social post analysis system 65. The cognitive social network posting listener 61 also considers the user profile to determine the possibility of non-authorized access/action. The cognitive social post analysis system 65 may be triggered based on previously established configuration of user restriction for content containing certain characteristics (topics, mood, personality) that are not commonplace for the user. In one embodiment, the cognitive social post analysis system 65 posts content in which differs only slightly from the baseline or the user is notified prior to a post being made. In another embodiment, the cognitive social post analysis system 65 analyzes possible variations of topics, mood, personality from the learned user profile and allowed posting of content related to the topics in the user profile, only if the mood and personality associated with the post does not differ significantly from the baseline. In this case, the topics of the post are not present in the user profile.

The user profile database 62 stores the user's personal information associated with a social media profile. The user profile can be used to identify if a user post does not follow the user's learned patterns but is within the “type” of messages sent by persons with similar profiles.

While the cognitive social post analysis system 65 is shown on the server computer 54, the system 65 may additionally be stored on at least one of one or more computer-readable tangible storage devices 830 shown in FIG. 2, on at least one of one or more portable computer-readable tangible storage devices 936 as shown in FIG. 2, or on storage unit connected to network 50, or may be downloaded for use. Alternatively, the cognitive social post analysis system 65 may be present on a node of a cloud computing environment.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). In this embodiment, the network 50 preferably includes a social network. FIG. 1 is intended as an example, and not as an architectural limitation, for the different illustrative embodiments.

FIG. 2 illustrates internal and external components of a device computer 52 and server computer 54 in which illustrative embodiments may be implemented. In FIG. 2, a device computer 52 and a server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and cognitive social post analysis system 65 are stored on one or more of the computer-readable tangible storage devices 830 for execution by one or more of the processors 820 via one or more of the RAMs 822 (which typically include cache memory). In the embodiment illustrated in FIG. 2, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. The cognitive social post analysis system 65 and/or components thereof can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. The cognitive social post analysis system 65 and/or components thereof can be downloaded to the device computer 52 and server computer 54 from an external computer via a network (for example, the Internet, a local area network or other, wide area network) and network adapter or interface 836. From the network adapter or interface 836, cognitive social post analysis system 65 and/or components thereof is loaded into hard drive 830. Cognitive social post analysis system 65 and/or components thereof can be downloaded to the server computer 54 from an external computer via a network (for example, the Internet, a local area network or other, wide area network) and network adapter or interface 836. From the network adapter or interface 836, cognitive social post analysis system 65 and/or components thereof are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Cognitive social post analysis system 65 and/or components thereof can be written in various programming languages including low-level, high-level, object-oriented or non object-oriented languages. Alternatively, the functions of the cognitive social post analysis system 65 and/or components thereof can be implemented in whole or in part by computer circuits and other hardware (not shown).

The cognitive social post analysis system 65 learns user behaviors in regards to posts by the user to at least one social media platform. The cognitive social post analysis system 65 ingests or records every user action relative to social media platforms to build a body of knowledge regarding the user. The system 65 extracts characteristics which includes sorting the information into user actions and into action fields, for example posting, likes, friend requests, chats, frequency of posting, etc.

Each action field is then further categorized into at least a first category based on content or context. For example, a posting may categorized into a first category of “Sports”. The categories may include, but are not limited to sports, political, sentimental, professional, other, family, etc. The posting may then be further categorized into a subcategory, such as “soccer” within the category of “sports”. The subcategorization of the post would continue until the post can no longer be further categorized.

As an example, a posting such as “Great game Saturday night between the Barcelona and German soccer teams as they try and reach the World Cup” could be categorized into Post-Sports-Soccer-Fan-World Cup-Barcelona-Germany, with the action field being “post”, the first category being “sports” and the subcategories being “soccer”, “fan”, “World Cup”, “Barcelona” and “Germany”.

Once the system 65 has enough data to establish a baseline of user knowledge and behavior, a neural network of the user's likes, dislikes is formed such that every action of the user triggers the system 65 to determine whether the action is within a threshold of the established baseline for the user. It should be noted that the baseline can be adjusted by the user to allow tighter restrictions on what is allowed to be posted without requiring multifactor authentication from the user. In another embodiment, the baseline can be controlled by a company the user works for and can be based on a baseline that reflects an entire user population of an entire company.

If the user's action is within the threshold, the action is completed relative to the social media platform and the action is added to the body of knowledge associated with the user and their profile for iterative learning.

If an action, such as a post by the user is outside of the threshold, the system 65 triggers a predetermined action such as a multifactor authentication request and/or prevention of the action for public display on the social media platform.

For example, a user's post may be determined to be outside of the threshold when the post is inciting violent protest, while 90% of the user's previous posts are sentimental in nature and the remaining 10% are about sports. In this example, the cognitive social post analysis system 65 would require multifactor authentication from the user prior to publishing the post to the social media platform.

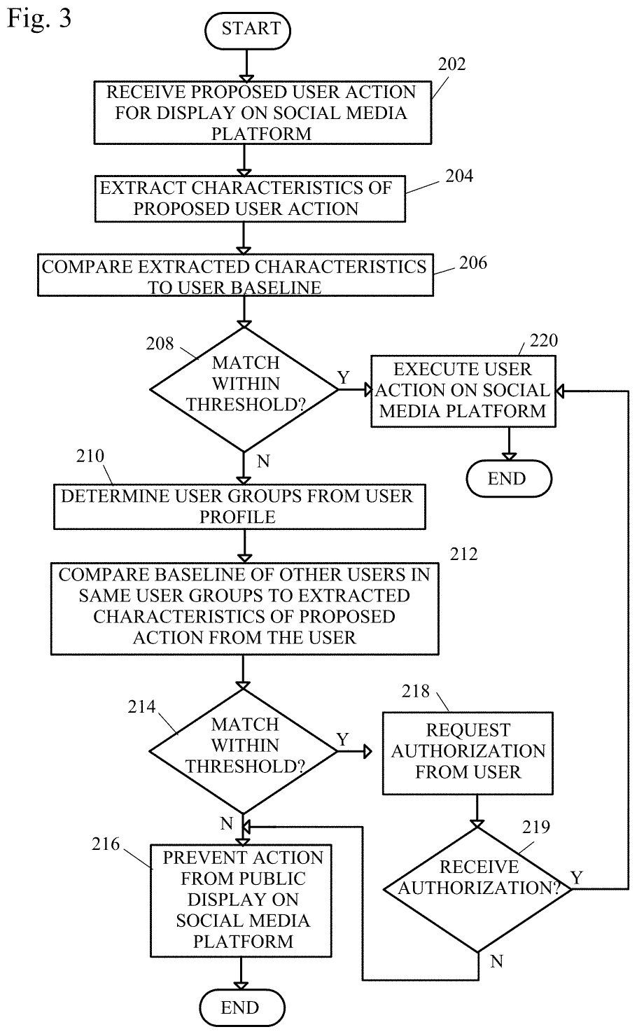

Prior to the method of FIG. 3, the baseline of user knowledge and behavior including user learned behaviors to form the user's neural network is established, including a baseline for the user.

Referring to FIG. 3, in a first step, the cognitive social post analysis system 65 receives a proposed user action for display on a social media platform (step 202). The proposed user action is an action that the user has initiated relative to the social media platform, but has not yet been published for others to see on the social media platform. The system 65 may receive this proposed user action via the cognitive social network posting listener 61.

Next, the system 65 extracts characteristics regarding context and content of the proposed user action (step 204), for example by the data classification module 60. As discussed above, the extracted characteristics are sorted into user actions, actions fields, a first category and subcategories.

The extracted characteristics are compared to the user baseline based on user learned patterns (step 206). During a training period, system 65 analyzes user activity, how the user writes, including topics (entities and their relationship), tones and personalities. For each of these elements a specific value is obtained and associated with a confidence level. For example, from user posted content, as an element topic, the classifier determined “sport/basketball” with a confidence of 90% and 70% respectively. Further analysis determines how many (percentage of posts) of the user are about sports on average and how many are about basketball. In this example 50% of the posts are about sports and 5% are for basketball. A baseline with an associated threshold is therefore created. Baselines and associates threshold are continuously updated based on user activity and feedback. A database containing historic data regarding posts, baselines and associated thresholds may be maintained. A baseline and associated threshold are similarly established for tone and personality based on an average percentage and confidence level.

If the comparison between the characteristics of the proposed user action to the user baseline differ less than a determined threshold (yields a match within a threshold) (step 208), the user action is executed on the social media platform (step 220) and the method ends.

If the comparison between the characteristics of the proposed user action to the user baseline differs more than a determined threshold (yields a match outside of the threshold) (step 208), the system 65 determines user groups the user belongs to, based on the user profile (step 210).

The system 65 compares the baseline of others in the same user groups to extracted characteristics of the proposed action of the user (step 212).

If the comparison between the baseline of others in the same user groups to extracted characteristics of the proposed action of the user differs more than a determined threshold (yields a match outside of the threshold) (step 214), the system 65 prevents the action from public display on the social media platform (step 216) and the method ends. It should be noted that a notification of some kind may be sent to the user regarding the prevented action. The determined threshold is a configurable number, for example ±5% for topic, ±10% for tone. Anything outside of these determined thresholds triggers the system 65 and prevents the action from public display on the social media platform.

If the comparison between the baseline of others in the same user groups to extracted characteristics of the proposed action of the user differs less than a determined threshold (yields a match within the threshold) (step 214), the system sends a request for authorization from the user regarding the proposed action (step 218). If authorization is received from the user (step 219), the method proceeds to step 220 of the user action is executed on the social media platform and the method ends.

If authorization from the user is not received (step 219), the method continues to step 216 of preventing the action from public display on the social media platform and the method ends.

The request may be sent in numerous ways, which include, but is not limited to short message service (SMS), voice call, e-mail or other means. The request for authentication may include a time element such that a lack of response from the user within a specific time period causes the user action relative to the social media platform to be cancelled

### EXAMPLES

### Example #1

User A is using a shared computer at the airport for posting to their social network. User A leaves to catch their flight and forgets to log out of the shared computer. An unauthorized user B uses the same shared computer and finds the social network session open with access to user A's account. User B attempts to execute inappropriate posts and comments as User A. The cognitive social post analysis system 65 receives these posts and comments and extracts characteristics associated with the posts. The extracted characteristics of the posts of User B may be categorized as “post-car-swimsuit-model” and “comment-violent-protest”.

The extracted characteristics of User B's posts and comments are compared to User A's profile and user groups in which User A belongs to determine whether the extracted characteristics are associated with other users associated with those groups in which User A belongs. User A belongs to groups such as “Yankees Fan Group” and “Romantic Music for All” and other users in these groups have similar extracted characteristics in their posts. Since User A's previous posts are mostly characterized as “post-music-romantic-Luis_Miguel” and “comments-sports-Baseball-Fan-Yankees”, as are other posts by members of groups to which he belongs, and the attempted posts are the completely different “post-car-swimsuit-model” and “comment-violent-protest”, the posts and comments attempted to be made by User B do not fall within a threshold when compared to User A's neural network baseline of learned behaviors. Therefore, the posts and comments of User B are not allowed to display on the social network platform. The cognitive social post analysis system 65 sends a request for authentication to User A along with a copy of the posts and comments to be made. Feedback from User A would then determine whether the posts and comments were made to the social network platform. Additionally, a request for authentication is sent preferably via another medium of communication, for example an e-mail, text message, and voice call, as is known in the art of two-factor authentication to further determine that the user providing the feedback.

### Example #2

User A places their mobile device in their pocket and by mistake, the social media application on the mobile device is opened and movement of the device within the user's pocket results in a potential post of “xjdhdhdh”. The cognitive social post analysis system 65 receives this, and attempts to extract the characteristics of the post. Since the post is essentially gibberish, the extracted characteristics may be characterized as “post-unrecognized”. For extracted characteristics with “unrecognized”, instead of the incomprehensive wording being posted to the social media platform, the cognitive social post analysis system 65 sends a notification to the user about the potential post. The notifications may be sent via short message service (SMS), voice call, and/or e-mail.

### Example #3

Some posting may be considered offensive depending on the location of the user. Determined topics and expressions, including moods and/or personalities can be specifically marked within the system 65 as negative for a set location, population, user or other designation. Depending on the ranking of the negativity of the identified element based on how often the user discusses the negative marked topic, the recipients of the negative marked topic, the baseline for the user would be set along with the associated threshold. If a determined topic is considered to be too negative, the cognitive social post analysis system 65 sends a notification to the user about the potential post. The notifications may be sent via short message service (SMS), voice call, and/or e-mail.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for preventing unwanted or unauthorized actions on a social media platform of a user comprising the steps of:
a computer receiving a proposed user action for public display on a social media platform associated with a user's account;
the computer extracting characteristics of the proposed user action, the characteristics comprising context and content of the proposed user action;
the computer comparing the characteristics of the proposed user action to a user baseline associated with the user's account;
when the comparison of the characteristics of the proposed user action to the user baseline determines that the characteristics of the proposed user action and the user baseline differ more than a determined threshold, the computer determining user groups associated with the user of the user's account;
the computer comparing a baseline of other users in same determined user groups as the user of the user's account to the extracted characteristics of the proposed user action; and
when the characteristics of the proposed user action to the baseline of other users in the same determined user groups determines that the characteristics of the proposed user action and the baseline of other users in the same determined user groups differ more than a determined threshold, the computer preventing the action from public display on the social media platform associated with the user's account.

2. The method of claim 1, wherein the step of the computer extracting characteristics comprising context and content of the proposed user action further comprises the steps of the computer:
categorizing the proposed user actions into user action fields representing the proposed action on the social media platform;
categorizing the proposed user actions into a first category based on context and content; and
further categorizing the proposed user actions into subcategories.

3. The method of claim 1, wherein when the computer determines that the characteristics of the proposed user action differ less than the determined threshold from the user baseline, the computer executing the user action on the social media platform associated with a user's account.

4. The method of claim 1, wherein when the computer determines that the characteristics of the proposed user action differ more than the determined threshold from the baseline of other uses in the same determined user groups, the computer sending a request for authorization of the user action from the user.

5. The method of claim 4, wherein the request for authorization is an electronic communication selected from the group consisting of: e-mail, text message, and voice call.

6. The method of claim 4, further comprising if a response to the request for authorization is not received within a predetermined time, the computer preventing the action from public display on the social media platform associated with the user's account.

7. A computer program product for preventing unwanted or unauthorized actions on a social media platform of a user, the computer program product executed using a computer comprising at least one processor, one or more memories, one or more computer readable storage media, the computer program product comprising a computer readable storage medium having program instructions embodied therewith, the program instructions executable by the computer to perform a method comprising:
receiving, by the computer, a proposed user action for public display on a social media platform associated with a user's account;
extracting, by the computer, characteristics of the proposed user action, the characteristics comprising context and content of the proposed user action;
comparing, by the computer, the characteristics of the proposed user action to a user baseline associated with the user's account;
when the comparison of the characteristics of the proposed user action to the user baseline determines that the characteristics of the proposed user action and the user baseline differ more than a determined threshold, determining, by the computer, user groups associated with the user of the user's account;
comparing, by the computer, a baseline of other users in same determined user groups as the user of the user's account to the extracted characteristics of the proposed user action; and
when the characteristics of the proposed user action to the baseline of other users in the same determined user groups determines that the characteristics of the proposed user action and the baseline of other users in the same determined user groups differ more than a determined threshold, preventing, by the computer, the action from public display on the social media platform associated with the user's account.

8. The computer program product of claim 7, wherein the program instructions of extracting, by the computer, characteristics comprising context and content of the proposed user action further comprises the program instructions of:
categorizing, by the computer, the proposed user actions into user action fields representing the proposed action on the social media platform;
categorizing, by the computer, the proposed user actions into a first category based on context and content; and
further categorizing, by the computer, the proposed user actions into subcategories.

9. The computer program product of claim 7, wherein when the computer determines that the characteristics of the proposed user action differ less than the determined threshold from the user baseline, the computer executing the user action on the social media platform associated with a user's account.

10. The computer program product of claim 7, wherein when the computer determines that the characteristics of the proposed user action differ more than the determined threshold from the baseline of other uses in the same determined user groups, sending, by the computer, a request for authorization of the user action from the user.

11. The computer program product of claim 10, wherein the request for authorization is an electronic communication selected from the group consisting of: e-mail, text message, and voice call.

12. The computer program product of claim 10, further comprising if a response to the request for authorization is not received within a predetermined time, preventing, by the computer, the action from public display on the social media platform associated with the user's account.

13. A computer system for preventing unwanted or unauthorized actions on a social media platform of a user, the computer system comprising a computer comprising at least one processor, one or more memories, one or more computer readable storage media having program instructions executable by the computer to perform the program instructions comprising:
receiving, by the computer, a proposed user action for public display on a social media platform associated with a user's account;
extracting, by the computer, characteristics of the proposed user action, the characteristics comprising context and content of the proposed user action;
comparing, by the computer, the characteristics of the proposed user action to a user baseline associated with the user's account;
when the comparison of the characteristics of the proposed user action to the user baseline determines that the characteristics of the proposed user action and the user baseline differ more than a determined threshold, determining, by the computer, user groups associated with the user of the user's account;
comparing, by the computer, a baseline of other users in same determined user groups as the user of the user's account to the extracted characteristics of the proposed user action; and
when the characteristics of the proposed user action to the baseline of other users in the same determined user groups determines that the characteristics of the proposed user action and the baseline of other users in the same determined user groups differ more than a determined threshold, preventing, by the computer, the action from public display on the social media platform associated with the user's account.

14. The computer system of claim 13, wherein the program instructions of extracting, by the computer, characteristics comprising context and content of the proposed user action further comprises the program instructions of:
categorizing, by the computer, the proposed user actions into user action fields representing the proposed action on the social media platform;
categorizing, by the computer, the proposed user actions into a first category based on context and content; and
further categorizing, by the computer, the proposed user actions into subcategories.

15. The computer system of claim 13, wherein when the computer determines that the characteristics of the proposed user action differ less than the determined threshold from the user baseline, the computer executing the user action on the social media platform associated with a user's account.

16. The computer system of claim 13, wherein when the computer determines that the characteristics of the proposed user action differ more than the determined threshold from the baseline of other uses in the same determined user groups, sending, by the computer, a request for authorization of the user action from the user.

17. The computer system of claim 16, wherein the request for authorization is an electronic communication selected from the group consisting of: e-mail, text message, and voice call.

18. The computer system of claim 16, further comprising if a response to the request for authorization is not received within a predetermined time, preventing, by the computer, the action from public display on the social media platform associated with the user's account.
